(19) United States
(12) Patent Application Publication
(10) Pub. No.: US 2026/0339686 A1
(43) Pub. Date: Oct. 29, 2026

(54) ELECTRONIC DEVICE, METHOD, AND NON-TRANSITORY COMPUTER-READABLE RECORDING MEDIUM FOR PROVIDING RECOMMENDED TASK

(71) Applicant: Samsung Electronics Co., Ltd., Suwon-si (KR)

(72) Inventors: Saejung SHIN, Suwon-si (KR); Kyunghak HYUN, Suwon-si (KR); Kyungtae KIM, Suwon-si (KR); Hyeoncheon JO, Suwon-si (KR)

(21) Appl. No.: 19/700,967

(22) Filed: Jun. 8, 2026

Related U.S. Application Data
(63) Continuation of application No. PCT/KR2025/009081, filed on Jun. 27, 2025.

(30) Foreign Application Priority Data
Jun. 28, 2024 (KR) 10-2024-0085277
Sep. 9, 2024 (KR) 10-2024-0122300

(51) Int. Cl. G06F 9/451; G06F 3/0482

(52) U.S. Cl. CPC G06F 9/453; G06F 3/0482

(57) ABSTRACT

An electronic device for providing a recommended task and a control method are provided. The electronic device includes a display, memory, including one or more storage media, storing instructions, and at least one processor, including processing circuitry, communicatively coupled to the display and the memory, wherein the instructions, when executed by the at least one processor individually or collectively, cause the electronic device to execute an intelligent assistant based on a first user input for executing the intelligent assistant; through the display, provide, at least one recommended task determined on the basis of context information related to the electronic device, through the display, obtain a second user input for selecting any one recommended task from among the at least one recommended task, based on obtaining the second user input, execute a task corresponding to the recommended task in a background, and based on completion of the task executed in the background, through the display, provide a guide message indicating that the task has been completed.

### CROSS-REFERENCE TO RELATED APPLICATION(S)

This application is a continuation application, claiming priority under 35 U.S.C. § 365(c), of an International application No. PCT/KR2025/009081, filed on Jun. 27, 2025, which is based on and claims the benefit of a Korean patent application number 10-2024-0085277, filed on Jun. 28, 2024, in the Ministry of Intellectual Property (MOIP), and of a Korean patent application number 10-2024-0122300, filed on Sep. 9, 2024, in the MOIP, the disclosure of each of which is incorporated by reference herein in its entirety.

### BACKGROUND

### 1. Field

The disclosure relates to an electronic device providing a recommended task, a method, and a non-transitory computer-readable recording medium.

### 2. Description of Related Art

More and more services and additional functions are being provided through electronic devices, e.g., smartphones, or other portable electronic devices. To meet the needs of various users and raise use efficiency of electronic devices, communication service carriers or device manufacturers are jumping into competitions to develop electronic devices with differentiated and diversified functionalities. Accordingly, various functions that are provided through electronic devices are evolving more and more.

The above information is presented as background information only to assist with an understanding of the disclosure. No determination has been made, and no assertion is made, as to whether any of the above might be applicable as prior art with regard to the disclosure.

### SUMMARY

According to the conventional art, in case of an artificial intelligence (AI) assistant implemented in an electronic device, e.g., a voice assistant service, the electronic device may need to receive all requisite parameters from a user in order to execute a designated task through the AI assistant. Further, according to the conventional art, while a task requested by a user is being performed, the user may not be able to perform other tasks in parallel. Further, since all processes/operations performed by the AI assistant are provided through a screen (e.g., a full screen) of a mobile device, a task being performed by the mobile device is interrupted, and a new task may not be performed until all processes/operations performed by the AI assistant are completed.

Aspects of the disclosure are to address at least the above-mentioned problems and/or disadvantages and to provide at least the advantages described below. Accordingly, an aspect of the disclosure is to provide an electronic device that provides task candidates highly likely to be performed at a current time point to a user through context-based inference and performs actions for performing a task selected by the user from among the provided task candidates in a background.

Another aspect of the disclosure is to provide a method of controlling an electronic device that provides task candidates highly likely to be performed at a current time point to a user through context-based inference and performs actions for performing a task selected by the user from among the provided task candidates in a background.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and at least one processor, including processing circuitry, communicatively coupled to the display and the memory. The instructions, when executed by the at least one processor individually or collectively, cause the electronic device to execute an intelligent assistant based on a first user input for executing the intelligent assistant, through the display, in response to execution of the intelligent assistant, provide at least one recommended task determined based on context information related to the electronic device, through the display, obtain a second user input selecting any one recommended task from among the at least one recommended task, based on obtaining the second user input, execute a task corresponding to the recommended task in a background, and based on completion of the task executed in the background, through the display, provide a guide message indicating that the task has been completed.

In accordance with another aspect of the disclosure, an electronic device is provided. The electronic device includes memory, including one or more storage media, storing instructions, and at least one processor, including processing circuitry, communicatively coupled to the memory. The instructions, when executed by the at least one processor individually or collectively, cause the electronic device to present a first user interface corresponding to a first application, detect a designated input through the first user interface, based on the designated input, obtain at least one recommended task, wherein the intelligent assistant is configured to identify the at least one recommended task based on context information including the first user interface. The instructions, when executed by the at least one hardware processor, cause the electronic device to use a machine learning model trained to generate a series of operations for executing each of the at least one recommended task, provide a list of tasks including the at least one recommended task through the first user interface, and in response to selection of the at least one recommended task, perform at least part of the series of operations in a background.

In accordance with another aspect of the disclosure, a method performed by an electronic device is provided. The method includes executing an intelligent assistant based on a first user input for executing the intelligent assistant, through a display of the electronic device, in response to execution of the intelligent assistant, providing at least one recommended task determined based on context information related to the electronic device, through the display, obtaining a second user input for selecting any one recommended task from among the at least one recommended task, based on obtaining the second user input, executing a task corresponding to the recommended task in a background, and based on completion of the task executed in the background, through the display, providing a guide message indicating that the task has been completed.

In accordance with another aspect of the disclosure, a method performed by an electronic device is provided. The method includes providing a first user interface corresponding to a first application, a detecting a designated input through the first user interface, obtaining at least one task based on the designated input, wherein each of the at least one task is executed by an operation sequence generated in the electronic device based on context information including the first user interface, executing a selected task from among the at least one task, and providing a second user interface corresponding to a second application during at least part of a time the selected task is executed and displaying a notification indicating an execution status of the selected task on the second user interface.

In accordance with an aspect of the disclosure, an electronic device is provided. The electronic device includes wireless communication circuitry, a display, memory, including one or more storage media, storing instructions, and at least one processor, including processing circuitry, communicatively coupled to the wireless communication circuitry, the display, and the memory. The instructions, when executed by the at least one processor individually or collectively, cause the electronic device to present, via the display, content obtained using the wireless communication circuitry, receive a first input during presentation of the content, the first input corresponding to a command to take a screenshot, present, based on the first input, a user interface element for adding an event to a calendar, the event being identified based on the content, and add the event to the calendar based on a second input received via the user interface element, during presentation of the content.

In accordance with another aspect of the disclosure, a method performed by an electronic device is provided. The method includes presenting, via a display of the electronic device, content obtained using wireless communication circuitry of the electronic device, receiving a first input during presentation of the content, the first input corresponding to a command to take a screenshot, presenting, based on the first input, a user interface element for adding an event to a calendar, the event being identified based on the content, and adding the event to the calendar based on a second input received via the user interface element, during presentation of the content.

In accordance with another aspect of the disclosure, one or more non-transitory computer-readable recording media storing instructions that, when executed by at least one processor of an electronic device individually or collectively, cause the electronic device to perform operations, is provided. The operations include presenting, via a display of the electronic device, content obtained using wireless communication circuitry of the electronic device, receiving a first input during presentation of the content, the first input corresponding to a command to take a screenshot, presenting, based on the first input, a user interface element for adding an event to a calendar, the event being identified based on the content, and adding the event to the calendar based on a second input received via the user interface element, during presentation of the content.

According to an embodiment of the disclosure, at least one recommended task is provided based on context information related to an electronic device, so that an electronic device capable of performing a designated task through an AI model is provided even when a requisite parameter for performing the designated task is not obtained from a user.

According to an embodiment of the disclosure, a task designated by a user is performed in a background, so that an electronic device capable of performing another task designated by the user even while performing the designated task is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment of the disclosure;

FIG. 2 is an example view illustrating a function or operation of an electronic device providing at least one recommended task based on context information related to the electronic device and executing a recommended task selected by a user, according to an embodiment of the disclosure;

FIG. 3 is a block diagram illustrating an electronic device configured to perform a function or operation of providing at least one recommended task and executing a recommended task selected by a user, according to an embodiment of the disclosure;

FIG. 4 is an example view illustrating a function or operation of an electronic device generating a prompt based on context information and providing at least one recommended task based on the generated prompt, according to an embodiment of the disclosure;

FIG. 5 is an example view illustrating a function or operation of an electronic device performing task planning according to a selection input of a user for at least one recommended task, according to an embodiment of the disclosure;

FIG. 6 is an example view illustrating a function or operation of an electronic device determining whether at least one requisite parameter has all been provided and executing a designated task in a background based on the determination, according to an embodiment of the disclosure;

FIG. 7 is an example view illustrating a function or operation of an electronic device transmitting information about an article provided through an internet browser to a counterpart device, from a user interface perspective, according to an embodiment of the disclosure;

FIG. 8 is an example view illustrating a function or operation of adding a schedule after a user of an electronic device ends a call with a user of a counterpart device, from a user interface perspective, according to an embodiment of the disclosure;

FIG. 9 is an example view illustrating a function or operation of an electronic device performing a money transfer to a user of a counterpart device, from a user interface perspective, according to an embodiment of the disclosure;

FIGS. 10A, 10B, and 10C are example views illustrating a function or operation of an electronic device sharing reservation information with a counterpart device and adding a schedule to the electronic device, from a user interface perspective, according to various embodiments of the disclosure;

FIG. 11 is an example view illustrating a function or operation of an intelligent assistant being continuously used while a designated application is being executed, from a user interface perspective, according to an embodiment of the disclosure;

FIG. 12 is an example view illustrating a function or operation of an electronic device providing at least one recommended task and summarizing and providing a new message when a message application is executed through a notification of the message application, from a user interface perspective, according to an embodiment of the disclosure; and

FIG. 13 is an example view illustrating a function or operation of an intelligent assistant being continuously used while a designated application is being executed, from a user interface perspective, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

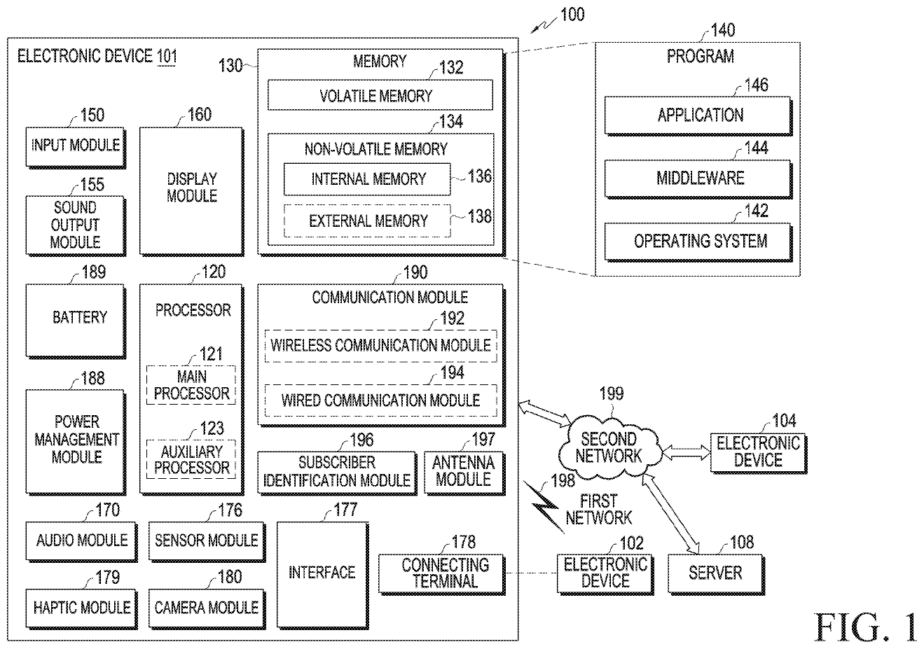

FIG. 1 is a block diagram illustrating an electronic device 101 in a network environment 100, according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The number of processors 120 may be one or more. For example, the processor 120 may have a structure of a multi-core processor such as dual core, quad core, or hexa core.

The processor 120 may control the operations of the electronic device 101 by executing the instructions stored in the memory 130. For example, the processor 120 may correspond to a plurality of processors that divide a plurality of operations between processors and collectively perform the operations.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing recordings. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be integrated into one component (e.g., a single chip) or implemented as a plurality of separate components (e.g., a plurality of chips). The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

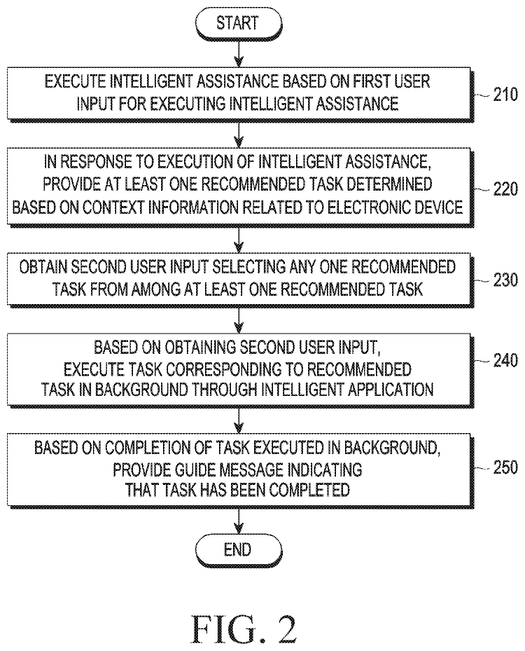

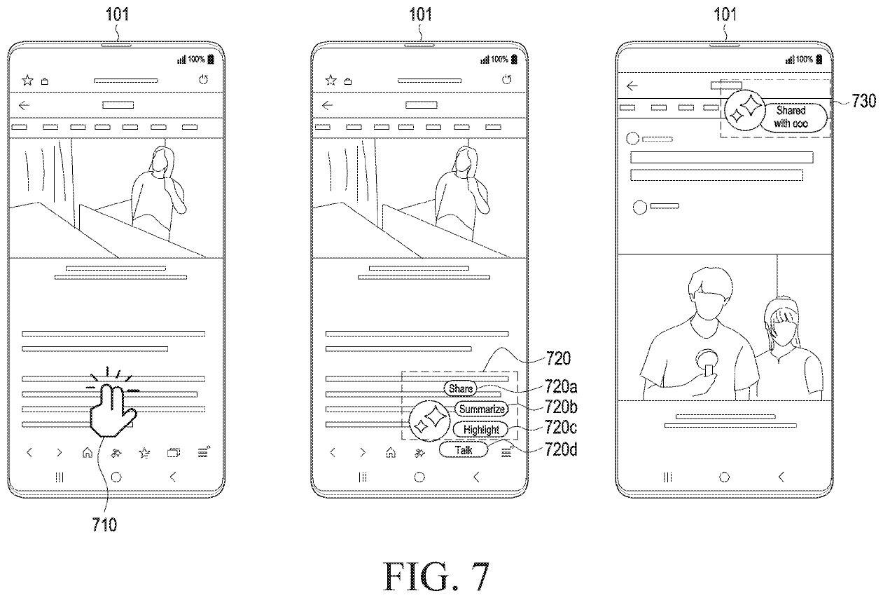

FIG. 2 is an example view illustrating a function or operation of an electronic device 101 providing at least one recommended task (e.g., the at least one recommended task 720 of FIG. 7) based on context information related to the electronic device 101 and executing a recommended task selected by a user, according to an embodiment of the disclosure.

The flowchart illustrated in FIG. 2 is merely a flowchart according to an embodiment of an operation of the electronic device 101, and a sequence of at least some operations may be changed, may be performed in parallel, may be performed as independent operations, or at least some other operations may be performed complementarily to at least some operations. According to an embodiment of the disclosure, operations 210 to 250 may be performed by the at least one processor 120 of the electronic device 101.

Referring to FIG. 2, in operation 210, the electronic device 101 according to an embodiment of the disclosure may execute an intelligent assistant (e.g., Samsung® Bixby™) based on a first user input for executing the intelligent assistant (e.g., Samsung® Bixby™). In the disclosure, although it is described that an intelligent assistant is executed for a function or operations related to a recommended task, this is for convenience of description, and at least part of a function or operations related to identification, suggestion, and/or execution of tasks according to various embodiments may be performed regardless of execution of the intelligent assistant. An intelligent assistant according to an embodiment of the disclosure may include a hardware and/or software module capable of bi-directional conversation with a user of an electronic device based on a trained machine learning model (e.g., artificial intelligence). The intelligent assistant may alternatively be referred to as an artificial intelligence assistant.

The electronic device 101 according to an embodiment of the disclosure may obtain the first user input regardless of a current state of the electronic device 101 (e.g., regardless of what screen the electronic device 101 is currently displaying). The first user input according to an embodiment of the disclosure may include, e.g., at least one of a touch gesture on the electronic device 101 (e.g., a double tap gesture on a touchscreen display, a long press on a designated area, and/or an edge sliding gesture), a voice command (e.g., “Hi Bixby!”), and/or an input on a hardware button (e.g., a volume control button) provided in the electronic device 101.

In operation 220, the electronic device 101 according to an embodiment of the disclosure may provide at least one recommended task (e.g., the recommended task 720 of FIG. 7) determined based on context information related to the electronic device 101 in response to execution of the intelligent assistant. The electronic device 101 according to an embodiment of the disclosure may obtain context information related to the electronic device 101 in order to provide at least one recommended task (e.g., the recommended task 720 of FIG. 7). The context information according to an embodiment of the disclosure may include at least one of information about at least one application being executed in a foreground (e.g., a name of the at least one application being executed in the foreground, a category to which the at least one application being executed in the foreground belongs, and/or a description of the at least one application being executed in the foreground), screen context information (e.g., information about an input UI object included in a screen currently being displayed through the electronic device 101, information about text included in a screen currently being displayed through the electronic device 101, information about an image included in a screen currently being displayed through the electronic device 101, and/or information about an available function included in a screen currently being displayed through the electronic device 101), activity information performed by a user in the past based on a current time point (e.g., for a recent month, after the electronic device 101 is switched from an off state to an on state, or after the electronic device 101 is connected to a specific network) (e.g., information about a time when a designated application (e.g., an application executed in the past) was executed, information about a location where the designated application was executed, information about a function executed in the past in association with the designated application, information about applications that were executed, and/or information about text that was input by the user), and/or information about an operable action of at least one or more applications installed in the electronic device 101 (e.g., information about a schedule registration action, information about a notification registration action, information about whether a camera is executable, information about whether a message is transmittable, information about a battery status, and/or information about whether wireless communication (e.g., Wi-Fi®) is connected). Some of the at least one or more applications may include an application installed without intervention of the user. The at least one or more applications according to an embodiment of the disclosure may be determined according to current context information (e.g., screen context information, activity information of the user, and/or status information of the device).

The at least one recommended task 720 according to an embodiment of the disclosure may include at least one action performing at least one application function. An “action” according to an embodiment of the disclosure may include at least one or more “application functions.” The at least one recommended task 720 according to an embodiment of the disclosure may refer to a set of at least one action that may be simultaneously or sequentially performed in the electronic device 101. According to an embodiment, the term “action” may be a term referring to a function provided by at least one application, and the term “operation” may be a term referring to each step constituting a procedure for performing a task. Each step (e.g., operation) constituting a procedure for performing a task may include one or more actions. According to an embodiment, one operation may correspond to one action. According to an embodiment, “action” and “operation” may be interchangeably/alternatively used.

The electronic device 101 according to an embodiment of the disclosure may generate a prompt for a machine learning model (or, a deep learning model or an AI model) to generate and/or determine at least one recommended task based on the obtained context information. For example, a prompt may include text, voice, audio, a still image, and/or a video. The machine learning model according to an embodiment of the disclosure may include a large language model (LLM) and/or a large vision model (LVM). A “prompt” mentioned in the disclosure is a software element input to an AI model (e.g., LLM) and may include a series of information for obtaining a designated response and/or for instructing or guiding performance of a designated task.

The electronic device 101 according to an embodiment of the disclosure may generate at least one prompt (e.g., a first prompt) in order to receive at least one recommended task 720 from the machine learning model 340. A first prompt according to an embodiment of the disclosure may include various first prompt elements, such as at least one of first, second, third, or fourth prompt elements. The first prompt element includes a first command for causing the machine learning model 340 to suggest at least one recommended task 720 using context information, description of a role as the intelligent assistant, and/or a response as the intelligent assistant, and description of result generation rules. The second prompt element includes at least part of the context information (e.g., activity history information). The third prompt element includes other context information except for at least part of the context information (e.g., activity history information) (e.g., information about a circumstance in which the user has just exchanged messages with “ooo,” information about a circumstance in which an application currently being used is “Internet” and the user is reading an article, text and image of an article recognized on the screen, information about a uniform resource locator (URL), information about a function list of all applications installed on the electronic device 101 of the user, and/or information about a wireless communication network currently being used by the electronic device). The fourth prompt element includes a description of output data (e.g., “share this article,” “summarize article,” “highlight,” and “talk” (provide recommended tasks suggested in natural language format considering priority and generate a function list corresponding to each recommended task in the background)). According to an embodiment of the disclosure, e.g., the first through fourth prompt elements may also be referred to by terms such as “instruction,” “context,” “input data,” and “output description,” respectively. For a prompt (e.g., the first prompt) to be input to a machine learning model according to an embodiment of the disclosure, a data platform 360 may be used that stores data (e.g., context information), a function list of all applications controllable in the electronic device 101, function-related information, a function repository, preference information of the user (e.g., activity history), and/or a usage pattern. For example, task candidates suitable to be performed subsequently may be determined by the machine learning model using information about an application currently being executed in the electronic device 101, an activity history of the user, and/or a usage pattern of the electronic device 101 by the user as input values. A task may include at least one action performing one or more application functions and may be simultaneously or sequentially performed. Examples of the first prompt element, second prompt element, and third prompt element are respectively shown in Table 1, Table 2, and Table 3 below.

A list of applications that may be provided by at least one external electronic device (e.g., a wearable device and/or an IoT device) connected to the electronic device 101 on which the intelligent assistant according to an embodiment of the disclosure is executed and operable actions, and context information of the at least one external electronic device (e.g., information about an application currently being executed, a status of the external electronic device (e.g., power on/off status, wireless communication connection status), and/or activity history) may also be collected and included in a prompt.

For example, the electronic device 101 according to an embodiment of the disclosure may identify a type of a wireless communication network (e.g., a cellular network as a first network) currently connected. The electronic device 101 according to an embodiment of the disclosure may generate a prompt so that a task executed only in a connection state of a second network (e.g., Wi-Fi) different from the identified network type is not output as a recommended task based on the identified network type (e.g., include a list of applications restricted while connected through the first network as context in the prompt and transmit to the learning model). Further, the electronic device 101 according to an embodiment of the disclosure may provide a notification that a task may be performed when connected to another wireless communication network (e.g., Wi-Fi) when a task including a restricted operation in a currently connected wireless communication network (e.g., cellular network) is suggested and selected. The electronic device 101 according to an embodiment of the disclosure may identify a current wireless communication connection status of the electronic device 101 and provide a recommended task based on the identified wireless communication connection status. For example, the electronic device 101 according to an embodiment of the disclosure may provide a task called “flash turn-on” as a recommended task to a user when the electronic device 101 is set to airplane mode.

The machine learning model according to an embodiment of the disclosure may determine a recommended task based on a task or function subsequently performed after the electronic device 101 has provided a screen (e.g., content including a soccer video) having a similarity equal to or greater than a predetermined level to a current screen. For example, when the intelligent assistant is called while outputting content including a soccer video, the electronic device 101 according to an embodiment of the disclosure may identify context information related to the soccer video, e.g., execution of a designated application (e.g., a food delivery application) and/or a function or operation of checking rankings of competing teams, and suggest a task for execution of the designated application (e.g., the food delivery application) and/or the function or operation of checking rankings of competing teams as a recommended task. Alternatively, the machine learning model according to an embodiment of the disclosure may determine a recommended task based on a task and/or function (e.g., a task and/or function provided after execution of a call application) subsequently performed when the electronic device 101 has provided a service through an execution order of an application used at a past time point (e.g., when a web browser application was executed after execution of a message application and then a call application was executed) or through a sequence having a similarity equal to or greater than a predetermined level to a menu usage order provided by the application (e.g., when a weather application was executed after execution of a message application and then a call application was executed). When an intelligent assistant is called, the electronic device 101 according to an embodiment of the disclosure may display edge lighting to intuitively guide the user that the intelligent assistant has been executed. The electronic device 101 according to an embodiment of the disclosure may display at least one recommended task after displaying the edge lighting or simultaneously with the edge lighting (e.g., display in a row/sequentially at the lower surface of the display 160). The examples may be included in a prompt as context information or as separate reference information or may be transmitted to the machine learning model together with the prompt.

The electronic device 101 according to an embodiment of the disclosure may determine and/or output at least one recommended task 720 based on the input prompt. For example, when identifying that the user has a history of using the message application immediately before executing the internet application and the activity history of the user indicates frequent use of the message application when sharing a web page and using a method of sharing a uniform resource locator (URL), the electronic device 101 (e.g., the machine learning model 340) according to an embodiment of the disclosure may determine and/or generate a “share” task as a recommended task. A “share” task according to an embodiment of the disclosure may be a task including a first action of obtaining URL information of a web page currently provided through the internet application and a second action of transmitting the URL information to a counterpart of the message application. Further, when identifying that the electronic device 101 is displaying a designated article through the internet application, the electronic device 101 (e.g., the machine learning model 340) according to an embodiment of the disclosure may determine and/or generate a “summarize” task as a recommended task. A “summarize” task according to an embodiment of the disclosure may be a task including a first action of summarizing an internet article currently being displayed through the electronic device 101 and a second action of providing the summarized information through the intelligent assistant. Alternatively, e.g., when identifying that the user has a history of making a call with a counterpart through a call application and performing a call recording function of the call application (e.g., exceeding a designated number of times), and that the user manages schedules through a calendar application, the electronic device 101 (e.g., the machine learning model 340) according to an embodiment of the disclosure may determine and/or generate a “call summary” task and/or a “wrap up call” task as a recommended task. A “call summary” task according to an embodiment of the disclosure may be a task including a first action of summarizing recorded call content and a second action of providing the summarized call content through the electronic device 101. For example, the electronic device 101 according to an embodiment of the disclosure may convert recorded call content into text, summarize the converted text through the machine learning model, and output the summarized text on a screen and/or convert the summarized text into voice and output the same.

A “wrap up call” task according to an embodiment of the disclosure may be a task including a first action of summarizing recorded call content and a second action of adding or modifying a schedule through the calendar application based on the summarized call content. Alternatively, e.g., when identifying that the user has a history of transmitting/receiving messages with a counterpart through the message application and the preference of the user indicates frequent use of a designated application when transferring money to the counterpart, the electronic device 101 (e.g., the machine learning model 340) according to an embodiment of the disclosure may determine and/or generate a “transfer” task as a recommended task. A “transfer” task according to an embodiment of the disclosure may include a first action of identifying information displayed on a current screen, identifying an account number, amount, and depositor name included in the screen, and/or providing a user identification message, a second action of performing a transfer through an application for transfer, which is frequently used when transferring money, after identification of the user, and a third action of providing a message indicating transfer completion after the transfer is completed. Alternatively, e.g., when identifying that the user is transmitting/receiving messages with a counterpart through the message application and the preference of the user indicates that schedule management is performed through the calendar application and a designated reservation application is mainly used when making a reservation, the electronic device 101 (e.g., the machine learning model 340) according to an embodiment of the disclosure may determine and/or generate a “deliver reservation information” task and/or a “save to calendar” task as a recommended task. A “deliver reservation information” task according to an embodiment of the disclosure may include a first action of obtaining reservation information provided through a reservation application frequently used by the user and a second action of transmitting the reservation information to a counterpart of the message application through the message application. A “save to calendar” task according to an embodiment of the disclosure may include a first action of obtaining reservation information provided through a reservation application frequently used by the user and a second action of storing the reservation information in the calendar application.

The electronic device 101 according to an embodiment of the disclosure may also provide an option in which at least one recommended task (e.g., the at least one recommended task 720 of FIG. 7) may be designated by the user. For example, in order for the electronic device 101 according to an embodiment of the disclosure to provide at least one recommended task 720, at least one application to be used for task performance may be designated in advance or in real-time by the user according to a location, time, and/or conversation counterpart. According to an embodiment, the machine learning model may use information about a recommended task and/or application designated by the user together with context information for determination and/or generation of a recommended task by receiving the information about the recommended task and/or application designated by the user as part of a prompt.

According to an embodiment, the at least one recommended task 720 may have classification information according to a style (e.g., category). For example, a style (e.g., category) of the at least one recommended task 720 to be suggested may be determined by the machine learning model 340 or may be designated by the user. The style thus determined or designated may be reflected in a design of a provided recommended task and/or a style of an automatically generated response. For example, when a style (e.g., category) of the at least one recommended task 720 to be suggested is a style included in a “regular” category, the at least one recommended task 720 to be provided may be provided in alphabetical order or may be provided in an order in which execution and/or selection of the at least one recommended task 720 is expected. For example, when a style (e.g., category) of the at least one recommended task 720 to be suggested is a style included in a “secure” category, the at least one recommended task 720 provided through the electronic device 101 may be provided so that personal information of the user is not used. Further, e.g., when a style (e.g., category) of the at least one recommended task 720 to be suggested through the electronic device 101 is a style included in a “workplace” or “work” category, a “professional” attribute rather than a “casual” attribute may be reflected in a style or tone of text generated through the at least one recommended task 720 to be provided.

A function or operation of providing the at least one recommended task 720 according to an embodiment of the disclosure may be provided according to priority. The electronic device 101 according to an embodiment of the disclosure may determine and provide at least one recommended task 720 from among a plurality of recommended tasks based on, e.g., a past usage pattern of the user (e.g., frequency of use of an application, frequency of an application used for a specific counterpart device, and/or a function frequently used per time period), a user profile (e.g., authorized permission per application), and/or status information history of the electronic device 101 (e.g., display the at least one recommended task 720). According to an embodiment of the disclosure, an operation of determining at least one recommended task 720 from among a plurality of recommended tasks and/or an operation of providing the at least one recommended task 720 (e.g., displaying the at least one recommended task 720) may be individually and/or collectively performed by the processor 120 of the electronic device 101 or the machine learning model.

The electronic device 101 according to an embodiment of the disclosure may obtain a function list (e.g., deep link, shortcut, intent, API, and function) of all applications installed in the electronic device 101 a usage pattern of the user, and/or preference information of the user in order to generate the first prompt. An example of the first prompt element according to an embodiment of the disclosure may include a prompt as shown in Table 1 below.

```
TABLE 1
  “Instruction”
  - AI Agent has system permission and the ability to recognize and process
information related to application interfaces, display content, system configurations,
pre-installed app functions, as well as user activity records and past interactions.
  - AI Agent requires user's explicit permission grant on such actions when
spending charges, or may expose personal status or notifying user's status.
  - Now, the circumstance is that the user has called out to AI agent because they
want something done automatically.
  - AI agent suggests the most suitable task candidates.
  - User is reading a news article through the Internet browser and calls out to the
user.
```

An example of the second prompt element according to an embodiment of the disclosure may include a prompt as shown in Table 2 below.

```
TABLE 2
  “Context”
  - The user is having a conversation about Legoland with their friend C (name,
Catherine, tel_num, 1-24-1512521, contact id, friend/25) through a messaging app.
  - The application currently in use is ‘Internet’
  - The smartphone is connected through WiFi (MYHOME-WIFI)
```

An example of the third prompt element according to an embodiment of the disclosure may include a prompt as shown in Table 3 below.

```
TABLE 3
  ″Input data″
  Application: Internet
  Usage: The user had been reading 10 articles over the course of 20 minutes.
  URL: https://www.news.com/news/read/1515815
  The contents of the news article are as follows in triple backticks
  ‘‘‘
  This library concert is a monthly program held since March, and 2,200 citizens
have participated so far.
  Previously, Legoland Korea Resort (hereinafter referred to as Legoland), a
global theme park, visited Kangwon National University Children's Hospital on the 19th
and conducted a ′visiting Lego Santa Claus′ for 50 children admitted to the pediatric
ward.
  There is an image in news article including the following content:
  Hospital, a hospital bed where a young patient is sitting, food on the bed, a Santa-
shaped human-sized Lego doll clapping in front of the bed.
```

The machine learning model 340 according to an embodiment of the disclosure may determine or generate at least one recommended task 720 based on the first prompt as above. The electronic device 101 according to an embodiment of the disclosure may provide the generated at least one recommended task 720. For example, the electronic device 101 may provide a list of the at least one recommended task 720 through a user interface (e.g., display on a screen or output through a speaker). In operation 230, the electronic device 101 according to an embodiment of the disclosure may obtain a second user input selecting any one recommended task (e.g., share) from among the provided at least one recommended task 720 (e.g., share, summarize, and/or highlight). For example, the electronic device 101 according to an embodiment of the disclosure may obtain a touch gesture for touching any one task among the at least one recommended task 720.

The electronic device 101 according to an embodiment of the disclosure may also receive a task (e.g., save an article currently being displayed) not included in the at least one recommended task 720. For example, the electronic device 101 may provide at least one recommended task 720 obtained using the machine learning model 340 and an additional item (e.g., a “talk” menu) together in the user interface. For example, the electronic device 101 according to an embodiment of the disclosure may obtain a command designating another task other than the at least one recommended task 720 by obtaining and receiving text, voice, and/or a visual element from the user through a “talk” function. Referring to FIG. 7, the at least one recommended task 720 according to an embodiment of the disclosure may include, e.g., a first recommended task 720a (e.g., “share”), a second recommended task 720b (e.g., “summarize”), and a third recommended task 720c (e.g., “highlight”). Further, a “talk” item may be provided as an additional item 720d. The first recommended task 720a (e.g., “share”) according to an embodiment of the disclosure may be a menu for performing a task of transmitting an internet article currently being displayed to a counterpart device. The second recommended task 720b (e.g., “summarize”) according to an embodiment of the disclosure may be a menu for summarizing an internet article currently being displayed and providing the same to the user. The third recommended task 720c (e.g., “highlight”) according to an embodiment of the disclosure may be a menu for highlighting (e.g., displaying a designated color on) at least part of an internet article currently being displayed. The additional item 720d (e.g., “talk”) according to an embodiment of the disclosure may be a menu for performing a bi-directional conversation with the intelligent assistant.

In operation 240, the electronic device 101 according to an embodiment of the disclosure may execute a task corresponding to the recommended task in a background through the intelligent assistant based on obtaining the second user input. According to an embodiment of the disclosure, some tasks among the at least one recommended task may have some functions or operations pre-performed in the background before the user selects the task. Such task pre-execution according to an embodiment of the disclosure may be executed according to a type or priority of a task in order to reduce a task performance time or may be executed for specific tasks in order to previously identify whether user approval is required during execution of the task.

When the second user input is obtained, the electronic device 101 according to an embodiment of the disclosure may perform task planning. For example, the task planning may refer to a function of identifying or generating a series of detailed operations for execution of a selected task. According to an embodiment, a series of operations or a sequence of operations identified or generated for execution of a task may include an operation or order not provided by a manufacturer of the electronic device 101 or a creator and/or manufacturer of an application. The electronic device 101 according to an embodiment of the disclosure may select an application and/or functions related to the corresponding task from a function repository and schedule functions for performing the task. The at least one recommended task 720 according to an embodiment of the disclosure may include at least one action performing at least one application function. An “action” according to an embodiment of the disclosure may include at least one or more “application functions.” The at least one recommended task 720 according to an embodiment of the disclosure may refer to a set of at least one action that may be simultaneously or sequentially performed in the electronic device 101. The electronic device 101 according to an embodiment of the disclosure may identify at least one application and/or function, determine priority for the at least one application and/or function, and generate a plan that may be performed continuously or in parallel. For example, when a task obtained from the user is composed of actions of translating an article currently being displayed, sharing the same with a friend, and adding a related schedule, the electronic device 101 may translate an article content obtained through the internet application into another language using the machine learning model, share the article with a counterpart device through a share function and the communication module 190, and schedule a new event to be added through the calendar application. A task planning function and/or operation according to an embodiment of the disclosure may also be performed in operation 220.

For example, the task planning function and/or operation may be performed through the machine learning model 340. A function of identifying a task to be provided or a function of generating a series of detailed operations for execution of each task according to an embodiment of the disclosure may include a function of determining what, when, to whom, where, and how to generate and provide.

To this end, when determining that at least one requisite parameter for determining what, when, to whom, where, and how to generate and provide is insufficient for performing task planning, the electronic device 101 according to an embodiment of the disclosure may further obtain insufficient information from the data platform 360 or request the user to input the at least one requisite parameter. The electronic device 101 according to an embodiment of the disclosure may perform a task according to a result of task planning. The electronic device 101 according to an embodiment of the disclosure may determine whether an requisite parameter is missing for performing the task. According to an embodiment of the disclosure, in order to perform a task such as a screenshot sharing function, information about a screen to be a target of the screenshot and a counterpart device to which a captured screen is to be shared is requested, so that such information may be preset as requisite parameters. When an requisite parameter is missing, the electronic device 101 according to an embodiment of the disclosure may obtain the requisite parameter from the data platform 360. The electronic device 101 according to an embodiment of the disclosure may obtain at least one of information about an application with the highest frequency of use, functions of an application frequently used (e.g., a screenshot sharing function, a URL sharing function, and a text sharing function), and information input in association with an application (e.g., contact information, schedule information, and location information). When all requisite parameters are obtained, the electronic device 101 according to an embodiment of the disclosure may execute the corresponding task in the background. Alternatively, when a parameter that is not an requisite parameter is insufficient, the electronic device 101 according to an embodiment of the disclosure may supplement an insufficient/missing parameter using information identified based on a function or operation that the user has frequently used based on an activity history of the user. For example, when sharing a photo taken with a counterpart after photo shooting, information about the counterpart device is an requisite parameter, but in which mode the photo was taken may not be an requisite parameter. Even in this case, the electronic device 101 according to an embodiment of the disclosure may identify that the user has frequently taken photos in a selfie mode based on the activity history of the user.

Accordingly, the electronic device 101 according to an embodiment of the disclosure may execute a camera application based on the selfie mode. In a process of executing a task according to an embodiment of the disclosure, content used for task execution may be generated. The content used for task execution according to an embodiment of the disclosure may be generated by the machine learning model 340.

The content used for task execution according to an embodiment of the disclosure may include text, voice, audio, a still image, and/or a video. According to an embodiment of the disclosure, the electronic device 101 may perform at least part of generation of the recommended task 720 (e.g., the first recommended task 720a (e.g., “share”), the second recommended task 720b (e.g., “summarize”), and the third recommended task 720c (e.g., “highlight”)), task planning, or content generation operation using an AI model (e.g., machine learning model) stored in the electronic device 101 and/or a remote AI model. According to an embodiment, the machine learning model 340 may correspond to the AI model stored in the electronic device 101. For example, the electronic device 101 may use the AI model stored in the electronic device 101 for generation of the recommended task 720 and use the remote AI model for generation of content. According to an embodiment, the AI model stored in the electronic device 101 or the remote AI model may be selectively used according to a type of content used for task execution. For example, when determining that generation or modification of text content is required in association with execution of a task, the electronic device 101 may generate or modify text content using the AI model (e.g., the machine learning model 340) stored in the electronic device 101. For example, when determining that generation or modification of multimedia content is required in association with execution of a task, the electronic device 101 may connect with a remote LLM server.

The electronic device 101 according to an embodiment of the disclosure may transmit a prompt for generation/modification of corresponding content to an external LLM server and receive generated/modified content from the external LLM server. The electronic device 101 according to an embodiment of the disclosure may generate a second prompt in order to perform task planning through the AI model (e.g., the machine learning model 340). According to an embodiment of the disclosure, the second prompt may include at least one of a fifth prompt element, a sixth prompt element, a seventh prompt element, or an eighth prompt element. The fifth prompt element includes a second command as basic instruction information for performing a task selected by the user (e.g., “share this article by discovering an appropriate recipient”). The sixth prompt element includes information to be checked for performing or completing the task (e.g., whether user identification is required for task performance completion). The seventh prompt element includes context information considered for task generation and/or context information collected at a time point when the task is performed (e.g., the user has just exchanged messages with “ooo,” an application currently being used is “Internet” and the user is reading an article, an application mainly used when sharing, a sharing method (e.g., screenshot, text copy, and/or URL), user pattern information, and/or a function list of all applications installed on the electronic device 101 of the user and function-related information). The eighth prompt element includes a sequence of functions of at least one application for performing the task (e.g., a function sequence including execution information so that the selected task may be performed).

The first prompt and/or the second prompt according to an embodiment of the disclosure may provide, to the machine learning model 340, what function the user of the electronic device 101 has executed before the current screen is displayed, what the user did in a similar circumstance (e.g., a circumstance in which specific applications are consecutively used) in the past, which application's screen the current screen is, which category the application belongs to, which menu the user has entered, and/or what text/image is being displayed.

The electronic device 101 according to an embodiment of the disclosure may provide a function list of all applications that may be provided through the electronic device 101 to the machine learning model 340 or may provide a function list of an application related to a task selected by the user to the machine learning model 340. For example, the electronic device 101 may also transmit a function list of applications that may be provided from an external device (e.g., the electronic device 102, the electronic device 104, or the server 108) connected to the electronic device 101 through a network (e.g., the first network 198 and the second network 199) to the machine learning model 340. According to an embodiment, when at least part of a task is performed using an external device, a guide message related to task performance may be displayed on the corresponding external device.

According to an embodiment, the machine learning model 340 may select an application and/or function for performing the at least one task 720 from the lists of applications and/or functions transmitted through the second prompt and generate a series of operations for performing the at least one task 720. In a process of selecting an application and/or function for performing the at least one task 720, at least one of information related to user preference, information related to usage history, a current location of the user, and a type of connectable network may be considered.

The second prompt according to an embodiment of the disclosure may include at least one of the fifth prompt element, the sixth prompt element, or the seventh prompt element that includes the prompts as shown in Table 4 below.

```
TABLE 4
  Fifth prompt element
  - AI Agent showed provided tasks to user.
  - and user decided to do task “Share”.
  - now AI Agent have to create a task with previously provided functions.
  Sixth prompt element
  - from the provided task and situation, fill up function uri and parameter and
execution order.
  - also AI Agent can use information from Data Platform.
  - Data Platform contains “Activity History”, “Task History”, “Function History
used for Tasks”, “Frequently used parameters”, “User preference”, “Activity History”
can provide user activity consists of “Application usage time” of “Activity name” and
“Package Name” based on datetime.
  -“Task History” can provide user frequently selected Task.
  -“Frequently used parameters” can provide parameters history for that Task.
  -“User preference” has information about user confirmation about following
system prompt.
  - Remember that AI Agent requires user's explicit permission grant on such
actions when spending charges, or can expose personal status or notifying user's status.
  Seventh prompt element
  - The user had shared 3 articles about travel to ‘Catherine’ yesterday.
  - The user had shared 2 summarized article to ‘Catherine’ yesterday.
```

The electronic device 101 according to an embodiment of the disclosure may identify a series of operations or a sequence of operations for performing the selected at least one task 720 based on a response to the second prompt output from the machine learning model 340 and perform the task by executing the series of operations. According to an embodiment, the electronic device 101 may perform the task in the background. For example, at least part of the series of operations may be executed in the background while a user interface on which the second user input was received or another user interface provided after the user interface is being provided to the user. According to an embodiment, the electronic device 101 may provide a guide message indicating that a task is being performed in the background or indicating what operation or step is being performed in the background.

In operation 250, the electronic device 101 according to an embodiment of the disclosure may provide a guide message indicating that the task has been completed based on completion of the task executed in the background. When background execution of the task is terminated, the electronic device 101 according to an embodiment of the disclosure may provide a guide message indicating that the task has been completed through the intelligent assistant.

The electronic device 101 according to an embodiment of the disclosure may generate content for an intermediate step of task performance or a response to be provided in a final step of task performance through the machine learning model 340. For example, when the user has requested message transmission together with an article, the electronic device 101 according to an embodiment of the disclosure may generate and provide a response such as “Article sharing has been completed” through the machine learning model 340. The electronic device 101 according to an embodiment of the disclosure may transmit an article or summary content of the article obtained according to performance of the task together with a generated message such as “Check out this article. I thought you'd be interested!” to another electronic device (e.g., the electronic device 104). The generated message (e.g., “Check out this article. I thought you'd be interested!”) according to an embodiment of the disclosure may be a phrase previously used by the user of the electronic device 101 or a message reflecting a phrase style (e.g., style and tone) frequently used by the user.

When completion of the task is identified, the electronic device 101 according to an embodiment of the disclosure may generate a third prompt for providing a guide message (e.g., “Sharing is complete!”) indicating that performance of the task has been completed. Alternatively, during performance of the task, the electronic device 101 according to an embodiment of the disclosure may generate a third prompt for providing a guide message (e.g., “An error occurred” or “Execution permission is required”) related to performance of the task. The third prompt according to an embodiment of the disclosure may be generated in a process of generating the task, in a process of generating a series of operations for performing the task, during performance of the task, or after performance of the task is completed. The third prompt according to an embodiment of the disclosure may include a prompt as shown in Table 5 below.

TABLE 5
- Task is carried out by AI Agent.
- Not AI Agent's responsibility to generate a text response for the user.
- AI Agent adheres to the following stylistic guidelines.
1. Prefers active voice over passive voice whenever possible.
2. Leans towards positive wording over negative.
3. Keep statements concise.
4. Avoids not use technical or robotic words.

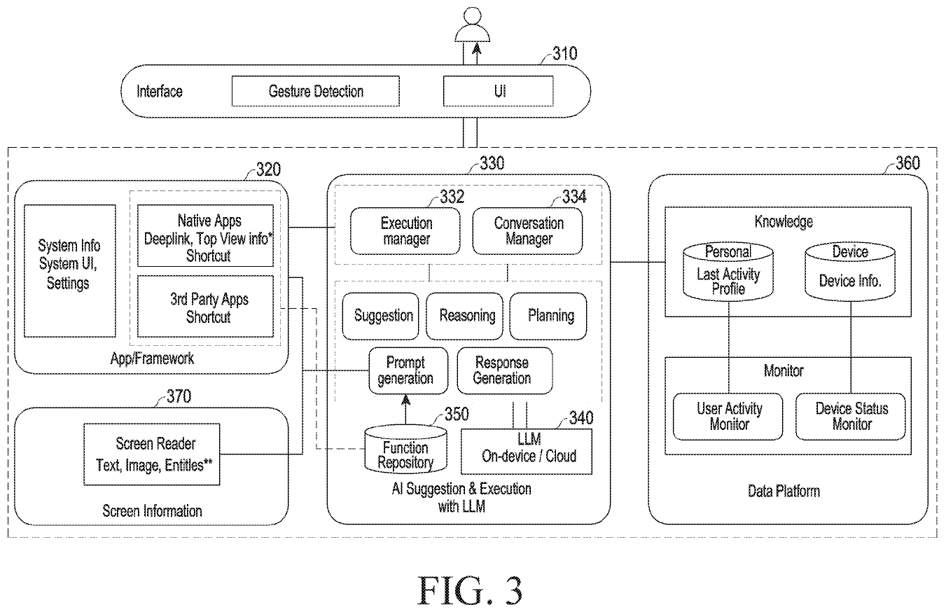

FIG. 3 is a block diagram illustrating the electronic device 101 configured to perform a function or operation of providing at least one recommended task 720 and executing a recommended task selected by a user, according to an embodiment of the disclosure.

The electronic device 101 according to an embodiment of the disclosure may include at least one of an interface module 310, a framework module 320, an AI inference module 330, a machine learning model 340 (e.g., LLM), a function repository 350, a data platform 360, and/or a screen information management module 370.

An interface module 310 according to an embodiment of the disclosure may include a module managing an interaction between a user and the electronic device 101. For example, in association with at least some of the embodiments of the disclosure, the electronic device 101 and the user may interact with each other through the intelligent assistant. The interface module 310 according to an embodiment of the disclosure may perform calling, requesting, suggesting, and/or responding. The interface module 310 according to an embodiment of the disclosure may provide a user interface used when the user calls the AI module (e.g., when at least one of voice, text input, and a specific gesture such as a double touch is input), delivers a request, the intelligent assistant suggests a task list, receives a request through a talk function, receives a prompt at an intermediate step of execution, and/or provides a task performance result.

A framework module 320 according to an embodiment of the disclosure may include a module managing and executing an application and a service package (e.g., capsule and domain) installed in the electronic device 101. The framework module 320 according to an embodiment of the disclosure may manage a function (e.g., deep link, shortcut, and intent) provided by the electronic device 101 and/or each application. A deeplink according to an embodiment of the disclosure may refer to an object moving to a designated application to display a screen desired by a user or induce a user action. A shortcut according to an embodiment of the disclosure may refer to an object providing a shortcut function or operation to a designated application. An intent according to an embodiment of the disclosure may refer to a software module, operation, or function for broadcasting an event occurring in an operating system of the electronic device 101 to an application. The framework module 320 according to an embodiment of the disclosure may be updated every time an application is installed/updated/deleted. The framework module 320 according to an embodiment of the disclosure may have function-related information (e.g., definition of each function, usage, and/or function description) stored therein.

An AI inference module 330 according to an embodiment of the disclosure may include an execution manager module 332, a dialog manager module 334, the function repository 350, and/or the machine learning model 340. The AI inference module 330 according to an embodiment of the disclosure may infer a task to be suggested to a user, configure and plan the task with sub actions/operations, and generate content used for completing task performance using generative AI (e.g., the machine learning model 340). The function repository 350 and/or the machine learning model 340 according to an embodiment of the disclosure may be stored in the data platform 360 or may be stored in another component. An execution manager module 332 according to an embodiment of the disclosure may obtain a result of task planning. The execution manager module 332 according to an embodiment of the disclosure may transmit a function for performing a task selected by the user to each application and system and perform the corresponding task. The execution manager module 332 according to an embodiment of the disclosure may complete performance of the corresponding task by obtaining requisite parameters used for performance of the task from the data platform 360. A dialog manager module 334 according to an embodiment of the disclosure may receive a response generated by the machine learning model 340 from the machine learning model 340. The dialog manager module 334 according to an embodiment of the disclosure may provide the response received from the machine learning model 340 to the user through the electronic device 101.

The data platform 360 according to an embodiment of the disclosure may include a module managing a history of use of the electronic device 101 by the user of the electronic device 101 and/or information of the electronic device 101. The data platform 360 according to an embodiment of the disclosure may manage an activity history performed before a current time point, an application and a function of the application used when the user performs a specific task, frequently used parameters, and/or preference information of the user. Further, the data platform 360 according to an embodiment of the disclosure may manage (e.g., store) a usage pattern such as whether to skip a step requiring identification of the user and content generated in a process of using an application.

A screen information management module 370 according to an embodiment of the disclosure may perform a function of reading a screen currently being displayed on the electronic device 101 and extracting meaningful information such as text and image when the user of the electronic device 101 calls the intelligent assistant. The electronic device 101 according to an embodiment of the disclosure may extract meaningful information using optical character recognition (OCR), image recognition, and/or scene recognition algorithm. A function or operation of extracting meaningful information by the electronic device 101 according to an embodiment of the disclosure may also be performed based on at least part of content disclosed in U.S. Application US 2023/0223008, the disclosure of which is incorporated by reference herein in its entirety. According to an embodiment of the disclosure, information (e.g., UI structure, accessibility information, and/or document object model (DOM)) constituting a current user interface may also be included in an extraction target of the screen information management module 370 even when not visible to the user.

According to an embodiment of the disclosure, a system of the disclosure including the above-described modules (e.g., the AI inference module 330) may include an AI hub (e.g., AI platform) structure in which at least some modules or part of sub components of the modules are driven by an always-on low-power AI processor (or engine). According to an embodiment of the disclosure, through the AI hub structure, an AI service of the disclosure suggesting a context-based recommended task may be provided by intelligently connecting not only various applications, functions, input/output interfaces, and/or power elements of the electronic device 101, but also a wearable device (e.g., smart watch, smart ring, and extended reality (XR)) operably connected to the electronic device 101, an IoT device (e.g., home appliance, access point, and speaker), a cloud server, and/or an automobile. For example, the at least one recommended task 720 may include a series of actions/operations that may be collectively performed through various devices (e.g., the electronic device 102, the electronic device 104, and the server 108) connected to the above-described AI hub structure. According to an embodiment, the function repository 350 may manage applications and/or functions that may be provided by various devices connected to the AI hub structure. These modules may include software or hardware driven by an application processor or a dedicated processor.

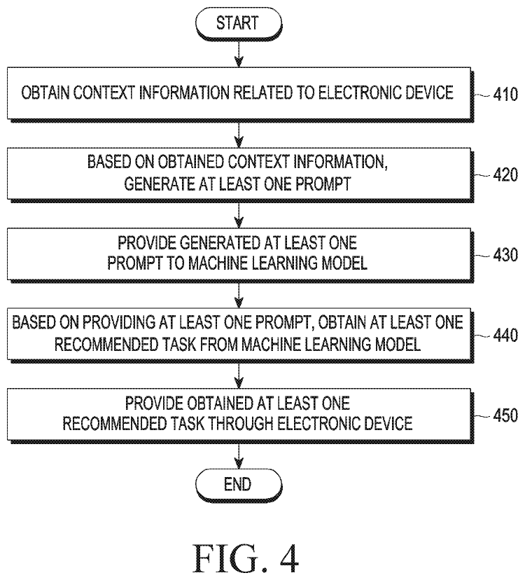

FIG. 4 is an example view illustrating a function or operation of the electronic device 101 generating a prompt based on context information and providing at least one recommended task 720 based on the generated prompt, according to an embodiment of the disclosure.

The flowchart illustrated in FIG. 4 is merely a flowchart according to an embodiment of an operation of the electronic device 101, and a sequence of at least some operations may be changed, may be performed in parallel, may be performed as independent operations, or at least some other operations may be performed complementarily to at least some operations. According to an embodiment of the disclosure, operations 410 to 450 may be performed by the at least one processor 120 of the electronic device 101.

Referring to FIG. 4, in operation 410, the electronic device 101 according to an embodiment of the disclosure may obtain context information related to the electronic device 101. The context information according to an embodiment of the disclosure may include at least one of information about at least one application being executed in a foreground (e.g., a name of the at least one application being executed in the foreground, a category to which the at least one application being executed in the foreground belongs, and/or a description of the at least one application being executed in the foreground), screen context information (e.g., information about an input UI object included in a screen currently being displayed through the electronic device 101, information about text included in a screen currently being displayed through the electronic device 101, information about an image included in a screen currently being displayed through the electronic device 101, and/or information about an available function included in a screen currently being displayed through the electronic device 101), activity information performed by the user in the past based on a current time point (e.g., information about a time when a designated application was executed, information about a location where the designated application was executed, information about a function executed in the past in association with the designated application, information about applications that were executed, and/or information about text that was input by the user), and/or information about an operable action of all applications installed in the electronic device 101 (e.g., information about a schedule registration action, information about a notification registration action, information about whether a camera is executable, information about whether a message is transmittable, information about a battery status, and/or information about whether wireless communication (e.g., Wi-Fi®) is connected).

In operation 420, the electronic device 101 according to an embodiment of the disclosure may generate at least one prompt based on the obtained context information. A prompt according to an embodiment of the disclosure may include at least one of a first prompt for receiving at least one recommended task 720 from the machine learning model 340, a second prompt for task planning, and a third prompt for providing a task performance result. For example, at least part of the first, second, and third prompts may be included in one prompt. According to an embodiment of the disclosure, operation 420 may be performed by the AI inference module 330.

In operation 430, the electronic device 101 according to an embodiment of the disclosure may provide the at least one prompt generated according to operation 420 to the machine learning model 340.

In operation 440, the electronic device 101 according to an embodiment of the disclosure may obtain at least one recommended task 720 and/or specification on a series of actions/operations for performing the recommended task from the machine learning model 340 based on providing the at least one prompt. Operations 430 and 440 according to an embodiment of the disclosure may be performed by the AI inference module 330.

In operation 450, the electronic device 101 according to an embodiment of the disclosure may provide the at least one recommended task obtained according to operation 440 through the electronic device 101. Operation 450 according to an embodiment of the disclosure may be performed by the interface module 310.

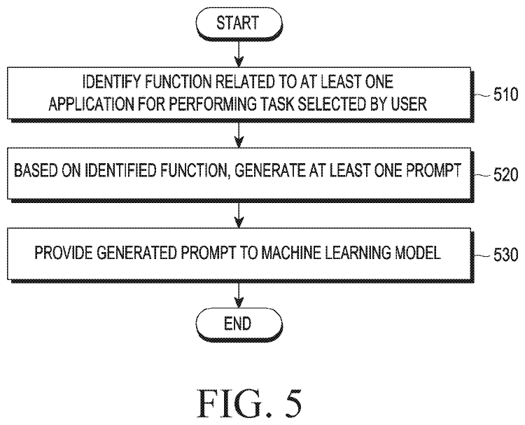

FIG. 5 is an example view illustrating a function or operation of the electronic device 101 performing task planning according to a selection input of a user for at least one recommended task 720, according to an embodiment of the disclosure.

The flowchart illustrated in FIG. 5 is merely a flowchart according to an embodiment of an operation of the electronic device 101, and a sequence of at least some operations may be changed, may be performed in parallel, may be performed as independent operations, or at least some other operations may be performed complementarily to at least some operations. According to an embodiment of the disclosure, operations 510 to 530 may be performed by the at least one processor 120 of the electronic device 101.

In operation 510, the electronic device 101 according to an embodiment of the disclosure may identify a function related to at least one application for performing a task selected by the user (e.g., the task selected in operation 230 of FIG. 2). For example, the electronic device 101 according to an embodiment of the disclosure may identify at least one application and/or function, determine priority for the at least one application and/or function, and generate a plan that may be performed continuously or in parallel.

In operation 520, the electronic device 101 according to an embodiment of the disclosure may generate at least one prompt (e.g., a second prompt) based on the identified function. According to an embodiment of the disclosure, the second prompt may include at least one of a fifth prompt element including a second command for performing the task (e.g., “share this article by discovering an appropriate recipient”), a sixth prompt element including information about whether identification of the user is required for completion of performing the task (e.g., whether user identification is required for task performance completion), a seventh prompt element including the context information (e.g., the user has just exchanged messages with “ooo,” an application currently being used is “Internet” and the user is reading an article, an application mainly used when sharing, a sharing method (e.g., screenshot, text copy, and URL), user pattern information, and/or a function list of all applications installed on the electronic device 101 of the user and function-related information), or an eighth prompt element including a sequence of functions of at least one application for performing the task (e.g., a function sequence including execution information so that the selected task may be performed). Operation 520 according to an embodiment of the disclosure may be performed by the AI inference module 330.

In operation 530, the electronic device 101 according to an embodiment of the disclosure may provide the generated prompt to the machine learning model 340. The electronic device 101 according to an embodiment of the disclosure may execute the task in the background based on a response to the second prompt output from the machine learning model 340. When it is identified that an requisite parameter is missing in a process of performing the task, the electronic device 101 according to an embodiment of the disclosure may obtain information about the requisite parameter from the data platform 360 or obtain information about the requisite parameter from the user. Execution of the task according to an embodiment of the disclosure may be performed by the execution manager module 332.

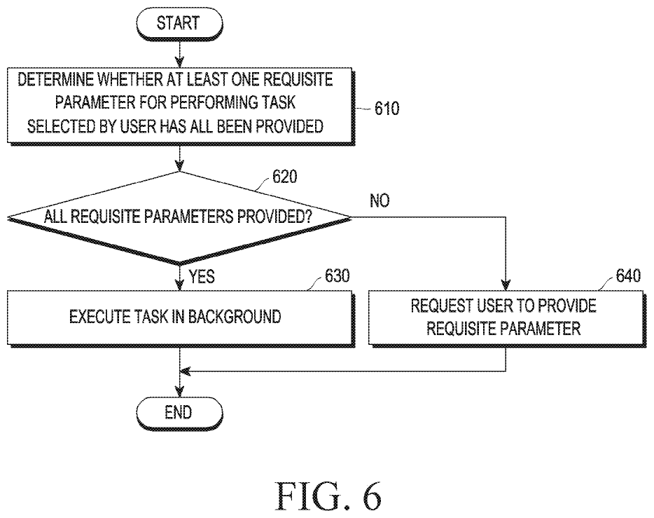

FIG. 6 is an example view illustrating a function or operation of the electronic device 101 determining whether at least one requisite parameter has all been provided and executing a designated task in a background based on the determination, according to an embodiment of the disclosure.

The flowchart illustrated in FIG. 6 is merely a flowchart according to an embodiment of an operation of the electronic device 101, and a sequence of at least some operations may be changed, may be performed in parallel, may be performed as independent operations, or at least some other operations may be performed complementarily to at least some operations. According to an embodiment of the disclosure, operations 610 to 640 may be performed by the at least one processor 120 of the electronic device 101.

Referring to FIG. 6, in operation 610, the electronic device 101 according to an embodiment of the disclosure may determine whether at least one requisite parameter for performing a task selected by the user has all been provided. To this end, the electronic device 101 may check a function sequence for performing the task based on the response generated through operation 530 of FIG. 5 and identify whether parameters included in the function sequence have been determined. In operation 620, the electronic device 101 according to an embodiment of the disclosure may determine whether all requisite parameters have been provided. Operations 610 and 620 according to an embodiment of the disclosure may be executed by the execution manager module 332.

In operation 630, when determining that all requisite parameters have been provided (e.g., operation 620—Yes), the electronic device 101 according to an embodiment of the disclosure may execute the task in the background. In operation 640, when determining that all requisite parameters have not been provided (e.g., operation 620—No), the electronic device 101 according to an embodiment of the disclosure may request the user to provide a requisite parameter. Operation 640 according to an embodiment of the disclosure may be performed by the dialog manager module 334.

FIG. 7 is an example view illustrating a function or operation of the electronic device 101 transmitting information about an article provided through an internet browser to a counterpart device, from a user interface perspective, according to an embodiment of the disclosure.

Referring to FIG. 7, while a designated application (e.g., internet application) is being executed, the electronic device 101 according to an embodiment of the disclosure may obtain a user input (e.g., a first user input 710) for calling the intelligent assistant from the user. The electronic device 101 according to an embodiment of the disclosure may provide at least one recommended task 720 (e.g., share 720a, summarize 720b, highlight 720c, and talk 720d) based on the first user input 710. “Talk” according to an embodiment of the disclosure may be an option for calling a conversational AI assistant. Through the “talk” function of the disclosure, after receiving a text or voice command of the user, a request of the user may be performed based on at least one of information of the data platform 360 (e.g., user preference and device status), information of the screen information management module 370, and information of the framework module 320, and not only a performance result but also a suggestion on recommended tasks related to the performance result may be provided to the user together.

The at least one recommended task 720 according to an embodiment of the disclosure may also be provided without the user input for calling the intelligent assistant (e.g., the first user input). According to an embodiment of the disclosure, the at least one recommended task 720 may in at least some cases be provided based on at least one interaction of the user with the electronic device 101, instead of being provided based on the user input for calling the intelligent assistant (e.g., the first user input). For example, when the user checks a specific application for a designated time or more (e.g., executes in the foreground for a designated time or more), when the user selects a designated object (e.g., text and/or menu included in an application execution screen), when the user commands performance of a designated function (e.g., captures a screen and/or takes a photo of a designated subject), when the user commands download of a designated file, or when the user commands transmission of a designated message to a counterpart device, the electronic device 101 according to an embodiment of the disclosure may generate a prompt in the background and/or execute or call the intelligent assistant based thereon. As may be appreciated from the above examples, the at least one interaction of the user with the electronic device 101 may include one or more user inputs, for the at least one interaction, that is different than the user input for calling the intelligent assistant (e.g., the first user input). For example, in a case in which the at least one recommended task 720 is provided based on an instance of when the user commands performance of a designated function (e.g., captures a screen), the at least one recommended task 720 may be provided based on a user input to command capturing a screen. Alternatively, the electronic device 101 according to an embodiment of the disclosure may provide designated content to the user and also generate a prompt in the background and/or execute the intelligent assistant based on a response of the user to the provided content.

The electronic device 101 according to an embodiment of the disclosure may provide at least one recommended task 720 based on the generated prompt and/or the executed intelligent assistant. For example, when the user checks travel information about a specific region for a predetermined time or more, the electronic device 101 according to an embodiment of the disclosure may suggest at least one task expected to be desired by the user (e.g., summarizing and transmitting content included in a current screen to a counterpart who has recently shared travel information about the region and/or updating content included in the current screen to a document or app recording a travel schedule for the region) through the electronic device 101 without a user request.

The electronic device 101 according to an embodiment of the disclosure may perform at least one task (e.g., “share”) selected by the user in the background and provide a guide message 730 indicating a performance result while the designated application (e.g., internet application) or another application is being executed. According to an embodiment, the electronic device 101 may provide the guide message 730 through the intelligent assistant.

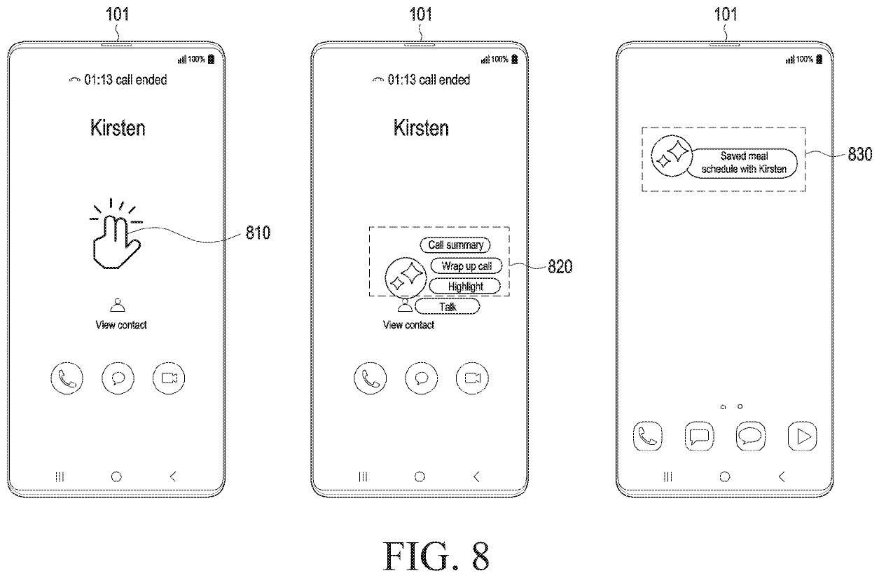

FIG. 8 is an example view illustrating a function or operation of adding a schedule after a user of the electronic device 101 ends a call with a user of a counterpart device, from a user interface perspective, according to an embodiment of the disclosure.

Referring to FIG. 8, after execution of the call application is terminated, the electronic device 101 according to an embodiment of the disclosure may obtain a user input (e.g., a first user input 810) for calling the intelligent assistant from the user. The electronic device 101 according to an embodiment of the disclosure may provide at least one recommended task 820. The electronic device 101 according to an embodiment of the disclosure may obtain a user input selecting any one task (e.g., “wrap up call”) from among the at least one recommended task 820. The electronic device 101 according to an embodiment of the disclosure may convert call recording content into text, summarize the call recording content, and extract key keywords (e.g., meal appointment, recipient, time, and location) based on the converted text and/or summarized content based on the input of the user. The electronic device 101 according to an embodiment of the disclosure may add or modify a schedule through the calendar application based on the extracted information and provide a guide message 830 indicating a performance result through the intelligent assistant.

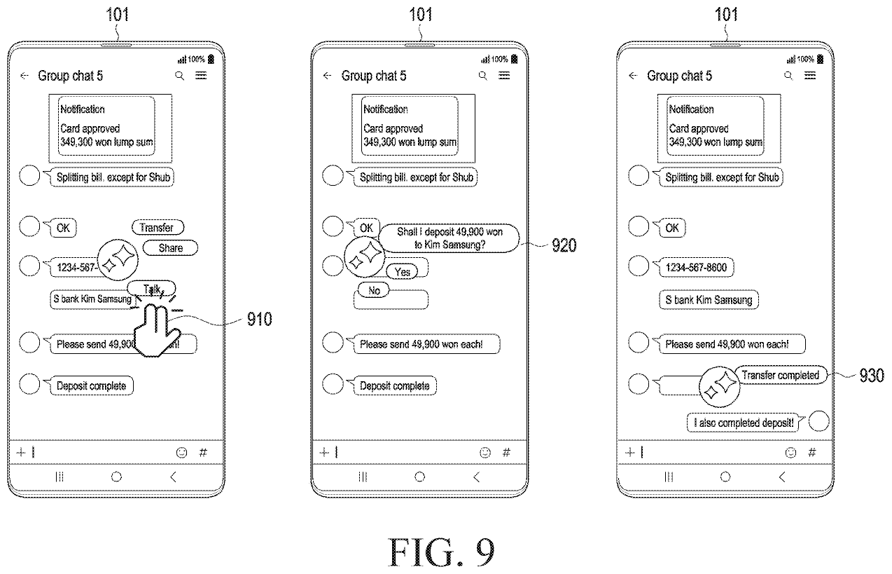

FIG. 9 is an example view illustrating a function or operation of an electronic device performing a money transfer to a user of a counterpart device, from a user interface perspective, according to an embodiment of the disclosure.

Referring to FIG. 9, while a screen including information for account transfer is displayed in a messenger application, the electronic device 101 according to an embodiment of the disclosure may obtain a user input (e.g., a first user input 910) for calling the intelligent assistant. The electronic device 101 according to an embodiment of the disclosure may provide at least one recommended task (e.g., “transfer,” “share,” and “talk”). The electronic device 101 according to an embodiment of the disclosure may obtain a user input selecting any one task (e.g., “transfer”) from among the at least one recommended task. The electronic device 101 according to an embodiment of the disclosure may identify whether a requisite parameter (e.g., account number, amount, and depositor name) for performing a “transfer” task is missing. When it is determined that a requisite parameter (e.g., account number, amount, and depositor name) for performing the “transfer” task is missing, the electronic device 101 according to an embodiment of the disclosure may extract information included in the screen and check information about the account number, amount, and depositor name. When information included in a sensitive information category (e.g., account number, resident registration number, password, user account, address, phone number, and amount) is extracted, the electronic device 101 according to an embodiment of the disclosure may output a guide message 920 for receiving identification from the user. Based on a user input selecting any one task (e.g., “transfer”) from among the at least one recommended task (e.g., “transfer,” “share,” and “talk”), when identification of the user for transfer is obtained, the electronic device 101 according to an embodiment of the disclosure may perform transfer through a transfer application most frequently used by the user of the electronic device 101. The electronic device 101 according to an embodiment of the disclosure may perform at least one task (e.g., “transfer”) selected by the user in the background and provide a guide message 930 indicating a performance result through the intelligent assistant.

Recommended tasks according to an embodiment of the disclosure may be classified into a task requiring approval of the user for execution of the task or at least part of a series of operations for execution of the task and a task not requiring approval of the user. According to an embodiment of the disclosure, tasks corresponding to each classification may be managed as a first type task and a second type task, respectively. According to an embodiment of the disclosure, different types of tasks in a user interface of a recommended task list (e.g., the at least one recommended task 720) may be displayed using different colors, fonts, sizes, and/or icons. According to an embodiment of the disclosure, when a task requiring approval of the user is selected, an additional interface requesting authentication (e.g., biometric authentication) of the user may also be provided at a time point of selecting the task, at a time point of starting the task, or during performance thereof. Biometric authentication at this step may include the same authentication as biometric authentication used for unlocking the mobile device. Biometric authentication at this step may correspond to biometric authentication pre-registered for an application used for task execution. The electronic device 101 according to an embodiment of the disclosure may generate a message to be input to the messenger application as part of an action of a task. The electronic device 101 according to an embodiment of the disclosure may display a generated message (e.g., “I've also completed the deposit!”) on a user input screen or display a user interface for identifying to the user whether to input the generated message.

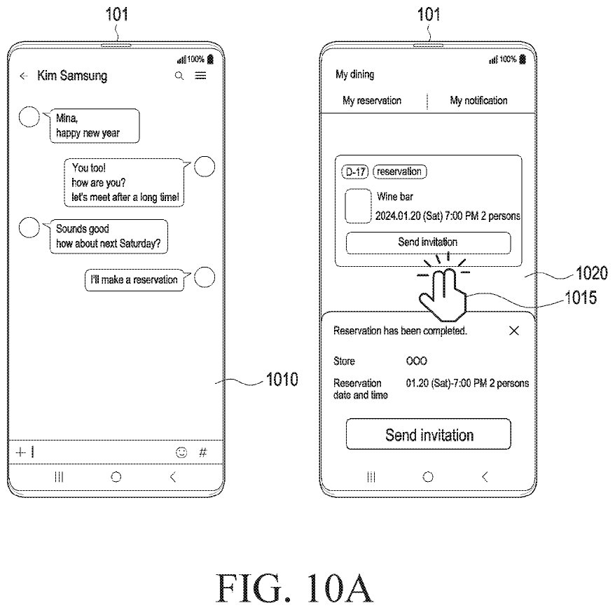

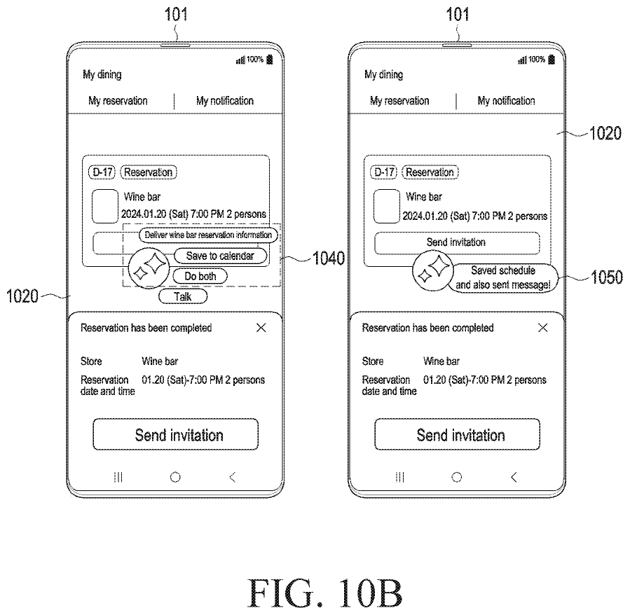

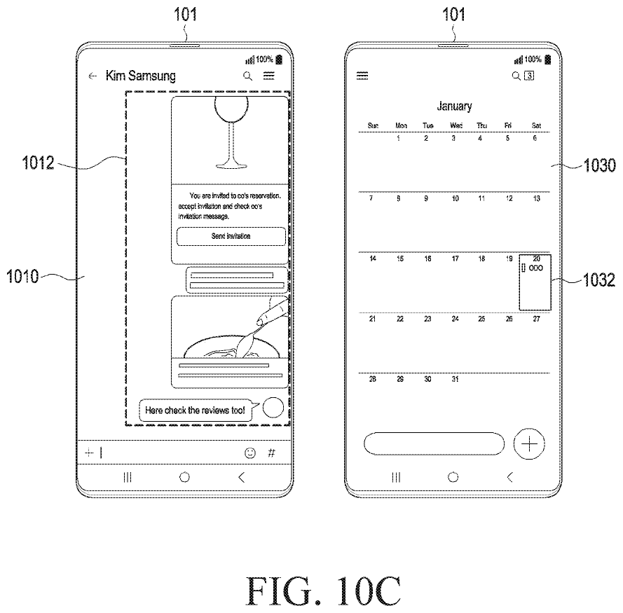

FIGS. 10A, 10B, and 10C are example views illustrating a function or operation of the electronic device 101 sharing reservation information with a counterpart device and adding a schedule to the electronic device, from a user interface perspective, according to various embodiments of the disclosure.

Referring to FIGS. 10A to 1 °C, while having a conversation with a counterpart through an execution screen 1010 of a message application, the electronic device 101 according to an embodiment of the disclosure may obtain a user input (e.g., a first user input 1015) for calling the intelligent assistant on an execution screen 1020 of a reservation application including a reserved store and reservation date and time information. The electronic device 101 according to an embodiment of the disclosure may provide at least one recommended task 1040 on the execution screen 1020 of the reservation application. The electronic device 101 according to an embodiment of the disclosure may obtain a selection input selecting any one task (e.g., “do both”) from among the at least one recommended task 1040 from the user. The electronic device 101 according to an embodiment of the disclosure may generate a new schedule 1032 in the calendar application using information included in the execution screen 1020 of the reservation application. The electronic device 101 according to an embodiment of the disclosure may display the new schedule 1032 on an execution screen 1030 of the calendar application. The electronic device 101 according to an embodiment of the disclosure may transmit reservation information about a “wine bar” to a counterpart device. In this case, a designated application (e.g., a message application) may be used. The electronic device 101 according to an embodiment of the disclosure may transmit at least one message 1012 generated by the machine learning model 340 to the counterpart device. The electronic device 101 according to an embodiment of the disclosure may perform at least one task (e.g., “do both”) selected by the user in the background and provide the guide message 1050 indicating a performance result through the intelligent assistant.

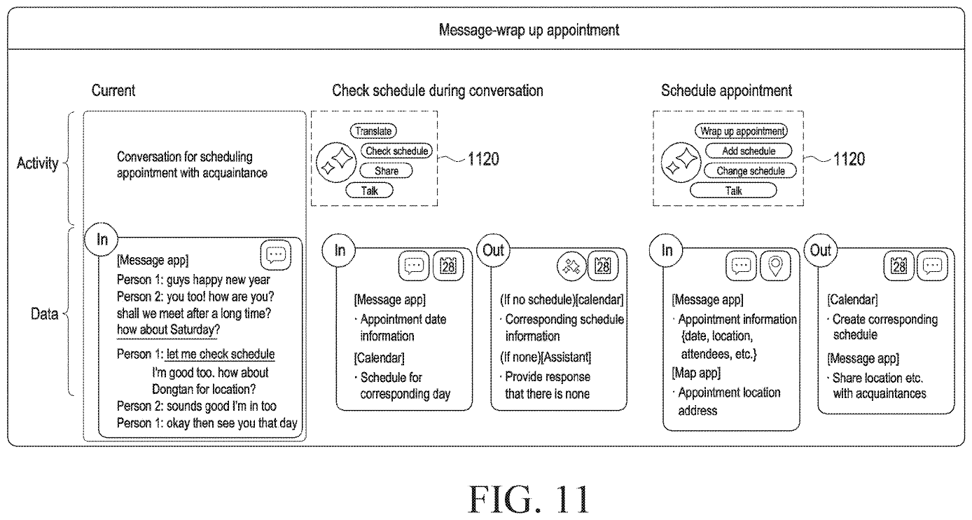

FIG. 11 is an example view illustrating a function or operation of the intelligent assistant being continuously used while a designated application is being executed, from a user interface perspective, according to an embodiment of the disclosure. In FIG. 11, “in” may refer to information input to the machine learning model 340, and “out” may refer to information output by the machine learning model 340.

Referring to FIG. 11, while the user is transmitting/receiving messages with a counterpart through a message application, in order to identify whether a schedule is stored on a specific date, the electronic device 101 according to an embodiment of the disclosure may obtain a first user input on an execution screen of the message application. The electronic device 101 according to an embodiment of the disclosure may provide at least one recommended task 1120 based on a first user input (e.g., the first user input 710). The electronic device 101 according to an embodiment of the disclosure may obtain a user input selecting at least one task (e.g., “check schedule”). The electronic device 101 according to an embodiment of the disclosure may perform the task (e.g., identify whether there is a schedule on a specific day) based on the obtained user input. The electronic device 101 according to an embodiment of the disclosure may provide a performance result (e.g., a schedule check result) of the task. The electronic device 101 according to an embodiment of the disclosure may obtain a first user input for re-calling the intelligent assistant on the execution screen of the message application. The electronic device 101 according to an embodiment of the disclosure may provide at least one recommended task 1120 based on obtaining the first user input for re-calling the intelligent assistant. The electronic device 101 according to an embodiment of the disclosure may obtain a user input selecting at least one task (e.g., “add schedule”). The electronic device 101 according to an embodiment of the disclosure may perform the task (e.g., generate and store a new schedule) based on the obtained user input. The electronic device 101 according to an embodiment of the disclosure may provide a performance result (e.g., generating and storing a new schedule) of the task. The electronic device 101 according to an embodiment of the disclosure may perform at least one task (e.g., “wrap up appointment”) selected by the user in the background (e.g., delete from a reminder, collect and automatically settle expenses, or post photos taken during the schedule to a social media) and provide a guide message (e.g., the guide message 730) indicating a performance result through the intelligent assistant. The electronic device 101 according to an embodiment of the disclosure may transmit at least one message generated by the machine learning model 340 to a counterpart device. In FIG. 11, the “talk” item is illustrated as an embodiment in which it is provided as a recommended task; however, this is merely an example, and the “talk” item may not be included in the recommended task 1120.

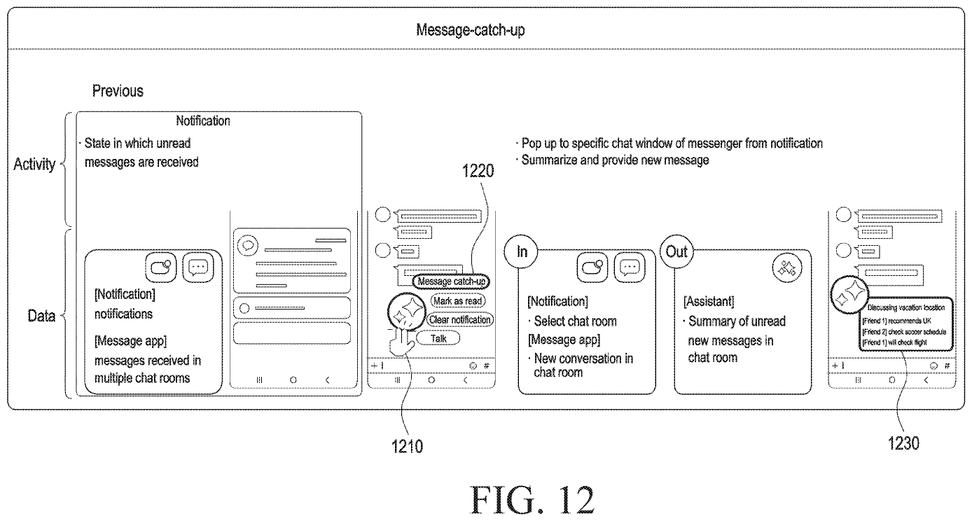

FIG. 12 is an example view illustrating a function or operation of the electronic device 101 providing at least one recommended task (e.g., the at least one recommended task 720) and summarizing and providing a new message when a message application is executed through a notification of the message application, from a user interface perspective, according to an embodiment of the disclosure.

Referring to FIG. 12, the electronic device 101 according to an embodiment of the disclosure may select a notification corresponding to the message application in a notification display area of a quick panel and enter the message application (e.g., display an execution screen of the message application). While the electronic device 101 according to an embodiment of the disclosure has entered the message application, it may obtain a first user input 1210 from the user. In response to the first user input 1210, the electronic device 101 according to an embodiment of the disclosure may provide a list including a message catch-up task 1220, a mark-as-read task, a clear notification task, and/or a talk item. At least one of the tasks or items displayed in the list may be generated by the machine learning model 340 based on context information. “Message catch-up” according to an embodiment of the disclosure may be a function or operation of summarizing and providing content of a plurality of messages not checked by the user. According to an embodiment of the disclosure, providing a summary of messages may be providing a summary summarizing unidentified content from all chat rooms at once, providing a separate summary for each chat room, providing a separate summary for each conversation counterpart, or providing a separate summary for each topic of conversation. “Clear notification” according to an embodiment of the disclosure may be a function or operation of deleting at least one notification from a notification window (e.g., a notification window where notifications of various applications are collectively provided). According to an embodiment of the disclosure, the “clear notification” task may include an operation of deleting a notification from the notification window, registering the same in a reminder application, and providing a reminder requesting identification to the user when the user continues not to check for a designated time. “Mark as read” according to an embodiment of the disclosure may be a function or operation of marking at least part of unidentified messages/notifications as read. The electronic device 101 according to an embodiment of the disclosure may perform a function or operation of displaying an additional user interface for selecting mark-as-read for each chat room, for each conversation counterpart, or for each message as at least part of functions or operations performed according to the “mark as read” task.

The electronic device 101 according to an embodiment of the disclosure may obtain a user input selecting any one task (e.g., “message catch-up”). The electronic device 101 according to an embodiment of the disclosure may perform the task (e.g., message catch-up) based on the obtained user input. The electronic device 101 according to an embodiment of the disclosure may provide a performance result (e.g., as a guide message 1230, provide a summary of conversation from messages not identified by the user) of the task. In FIG. 12, the electronic device 101 may identify a preference (e.g., history) of the user who frequently does not check notifications and checks them at once as an activity history of the user while many notifications are received to the electronic device 101. Such content is illustrated in FIG. 12 as phrases of “a state in which unread messages are received” and “messages received from multiple chat rooms.” The electronic device 101 according to an embodiment of the disclosure may enter the message application through a notification and summarize and provide content of a new message as part of performing the message catch-up task. Such a function or operation is illustrated in FIG. 12 as phrases of “enter a specific chat window of the messenger from the notification” and “summarize and provide a new message.”

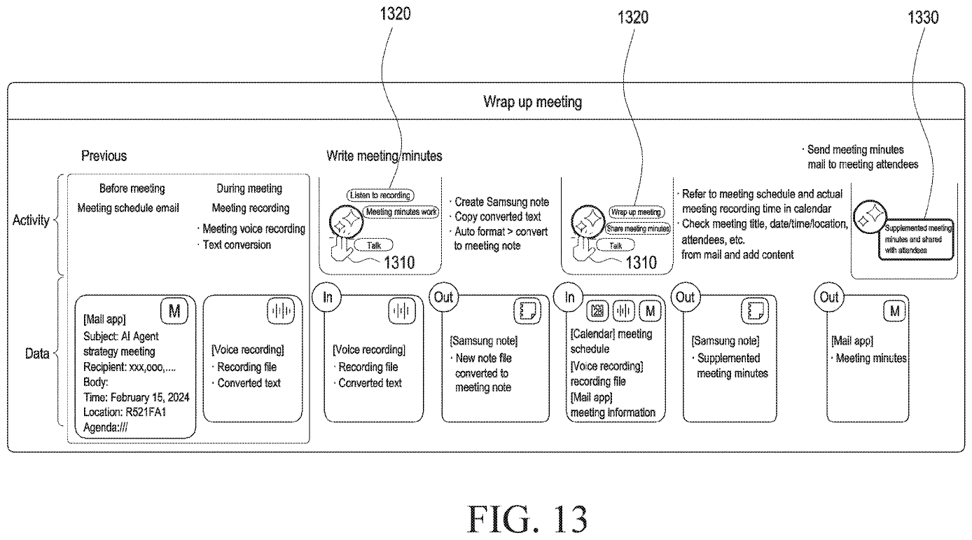

FIG. 13 is an example view illustrating a function or operation of an intelligent assistant being continuously used while a designated application is being executed, from a user interface perspective, according to an embodiment of the disclosure.

Referring to FIG. 13, the electronic device 101 according to an embodiment of the disclosure may execute a file converted from a voice recording file into text through a note application. In this state, the electronic device 101 according to an embodiment of the disclosure may obtain a first user input 1310. The electronic device 101 according to an embodiment of the disclosure may provide at least one recommended task 1320. The electronic device 101 according to an embodiment of the disclosure may obtain an input selecting any one task. After performing the task in the background, the electronic device 101 according to an embodiment of the disclosure may perform a task in the background and then provide a conversion result such that voice content converted into text is suitable for a meeting minutes format for each speaker. The electronic device 101 according to an embodiment of the disclosure may re-obtain a first user input 1310 on a converted meeting minutes screen. The electronic device 101 according to an embodiment of the disclosure may provide at least one recommended task 1320. The electronic device 101 according to an embodiment of the disclosure may obtain a user input selecting any one task (e.g., “wrap up meeting”). In the background, the electronic device 101 according to an embodiment of the disclosure may check a meeting schedule related to the meeting and attendee information. The electronic device 101 according to an embodiment of the disclosure may transmit content converted into meeting minutes to attendees through email and then provide an execution completion message (e.g., as a guide message 1330). In FIG. 13, the electronic device 101 may identify receiving a meeting-related email, recording voice during a meeting, and performing text conversion of a recording file as an activity history of the user and identify an activity history of writing meeting minutes and delivering the same to attendees after the meeting ends as preference information of the user. As data stored in the electronic device 101, information related to the meeting (e.g., meeting purpose, meeting location, and meeting time) may be stored through a mail application, and a recording file in which meeting content is recorded and data in which the recording file is converted into text may be stored through a voice recording application. When a meeting minutes writing recommended task is selected, the electronic device 101 according to an embodiment of the disclosure may execute a note application, copy converted text to the note application, and convert the same into a meeting note format. When a wrap up meeting recommended task is selected, the electronic device 101 according to an embodiment of the disclosure may store a meeting schedule and meeting recording time in the electronic device 101 through a calendar application and further store additional information (e.g., attendees and meeting title) in a text file converted into a meeting note format based on information stored through the mail application to generate meeting minutes. Further, the electronic device 101 according to an embodiment of the disclosure may transmit generated meeting minutes to meeting attendees through email as part of an operation for the wrap up meeting recommended task.

Referring to FIG. 13, the electronic device 101 according to an embodiment of the disclosure may provide “listen to recording,” “wrap up meeting,” and/or “share meeting minutes” tasks as a recommended task 1320. “Listen to recording” according to an embodiment of the disclosure may be a function or operation of outputting a recording file in which meeting content is recorded. “Share meeting minutes” according to an embodiment of the disclosure may be a function or operation of transmitting meeting minutes to meeting attendees through email. “Wrap up meeting” according to an embodiment of the disclosure may include a function or operation of storing a meeting schedule and meeting recording time in the electronic device 101 through the calendar application and further storing additional information (e.g., attendees and meeting title) in a text file converted into a meeting note format based on information stored through the mail application to generate meeting minutes.

In the disclosure, an intelligent assistant generating a recommended task and an operation sequence for each recommended task may use a machine learning model or an AI neural network. A machine learning model of the disclosure may be a model trained to detect a task likely to be executed subsequently based on context. For example, the machine learning model may be trained or learned to associate specific context with a specific task and a specific operation sequence through sufficiently large training data for context such as activity history, device status, and current user interface. The machine learning model of the disclosure may include various transformer models. An operation of the machine learning model of the disclosure may include learning and inference processes of discovering a pattern from data, storing the same as a model that is a generalized rule, and inputting new data as input to a learned model to obtain a result.

In a mobile device (e.g., the electronic device 101 of FIG. 1), manipulations by a user (e.g., functions repeatedly performed in a consistent order) may be monitored to train a machine learning model. The mobile device (e.g., App/Framework module and Data platform module) may provide, to the machine learning model, what functions the user used before and after execution of a communication application (email, short message service (SMS), social network service (SNS), phone, and meeting), where the location of the mobile device was at the time, what time period it was, what network was used, what function was automatically performed, what setting was additionally manually operated, and what topic the user had been exchanging with a specific counterpart for a predetermined period. Current user interface and previous activity history may be input values for learning, and subsequent user manipulations may correspond to target outputs. A machine learning model may learn a usage pattern of the user. Such learning may correspond to initial learning or may correspond to re-training. A learning process of the machine learning model may include forward propagation and backward propagation. For learning, an algorithm such as regression, decision tree, neural network, or k-nearest neighbor may be used. Different machine learning models may be used for each target task or each input context.

Hereinafter, a description of an LLM used in the disclosure is provided for convenience of description; however, it is obvious that the AI neural network of the disclosure may include various foundation models such as a code model and an image model as well as a language model and other AI neural network models.

An LLM mentioned in the disclosure may refer to an artificial neural network-based language model that has learned a large amount of text data through pre-training. An LLM may include relatively more parameters (e.g., 10 billion or more) than a conventional general language model. An LLM may use a transformer artificial neural network structure based on an attention mechanism.

The attention mechanism is a technology that helps the artificial intelligence model focus on important portions within input data. The attention mechanism may be used for output data prediction by predicting the degree to which at least a part of the time series input data (e.g., the input data of voice and video or input data of some layers of the neural network) contributes to the intermediate or final output of the neural network. The recurrent neural network (RNN) structure, which sequentially processes each element of a sequence, has poor prediction performance when there is information dependency between long time series distances, but the attention mechanism may consider information dependency between long time series distances by controlling the degree of weight attention within the context of the entire or part of the input data.

The transformer may be configured in an encoder-decoder structure. The encoder may process input data to output compressed information (e.g., contextual representation), and the decoder may process the compressed information to output output data in token units. Each of the encoder and decoder may include an independent attention network and may include a cross-attention network connecting the encoder and the decoder.

For example, LLM training may include pre-training and/or fine-tuning. Pre-training is a process that allows the LLM to obtain general language knowledge using a large amount of text data, and may include self-supervised learning, e.g., predicting the next word using the previous word string of the text string. Fine tuning is a process of training the LLM to suit specific domains (e.g., chatbot, translation, summary, Q&A), and the LLM may be additionally supervised trained (or adaptively trained) with datasets tailored to domain purposes based on pre-trained models. LLM may perform tasks with text input including natural language called prompts.

For example, fine tuning may be omitted when training the LLM. The user may control the prompts to be input to the LLM to enhance the performance of the desired task. A guide for performing a task and/or an example of a task may further be provided to the prompt in a manner like in-context learning or zero-shot/few-shot learning. Known LLMs include bidirectional encoder representations from transformer (BERT), generative pre-trained transformer (GPT).

The machine learning model 340 (e.g., LLM) according to an embodiment of the disclosure may additionally receive image (including video) information in addition to text. According to an embodiment of the disclosure, image information may be converted into text through separate prior conversion (e.g., image recognition and scene recognition), and the machine learning model 340 may generate a response by including the same in a prompt. As another example, the electronic device 101 may convert an input image into image embeddings aligned with text through an image encoder, and the machine learning model 340 may generate a response with a separately trained model (e.g., a large multimodal model) using text embeddings corresponding to input text.

The expression “LLM” may refer to a language neural network model itself; however, it may also refer to a model of an LLM-based application (e.g., chatbot, translation, summary, text classification, and sentence generation). For example, an LLM-based chatbot such as ChatGPT or an LLM-based translator may also be referred to as “LLM.”

“LLM” may also include an inference engine using an LLM neural network model. For example, “inputting the input prompt into the LLM” may mean “inputting the input prompt into the LLM-based inference engine.” For example, “an output of an LLM for an input prompt” may refer to output information of a last neural network layer of an LLM (or output information modified through additional processing) obtained when inputting an input prompt to an inference engine based on an LLM.

An electronic device 101 according to an embodiment of the disclosure includes a display, at least one hardware processor, and memory. The memory may be configured to store instructions that, when executed by the at least one hardware processor, cause the electronic device to: execute an intelligent assistant based on a first user input for executing the intelligent assistant, through the display, in response to execution of the intelligent assistant, provide at least one recommended task determined based on context information related to the electronic device, through the display, obtain a second user input selecting any one recommended task from among the at least one recommended task, based on obtaining the second user input, execute a task corresponding to the recommended task in a background through the intelligent assistant, and based on completion of the task executed in the background, through the display, provide a guide message indicating that the task has been completed.

An electronic device 101 according to an embodiment of the disclosure includes at least one hardware processor and memory. The memory may be configured to store instructions that, when executed by the at least one hardware processor, cause the electronic device to: present a first user interface corresponding to a first application, detect a designated input through the first user interface, based on the designated input, obtain at least one recommended task through an intelligent assistant, wherein the intelligent assistant is configured to identify the at least one recommended task based on context information including the first user interface and includes a machine learning model trained to generate a series of operations for executing each of the at least one recommended task, provide a list of tasks including the at least one recommended task on the first user interface, and in response to selection of the at least one recommended task, perform at least part of the series of operations in a background.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Terms such as “first”, “second”, or “first” or “second” may be used simply to distinguish the corresponding component from another corresponding component, and do not limit the corresponding components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be an integrally configured component or a minimum unit or part thereof performing one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor of the machine (e.g., the electronic device 2501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed in the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. In the case of online distribution, at least a part of the computer program product may be at least temporarily stored or temporarily generated in a machine-readable storage medium such as memory of a server of a manufacturer, a server of an application store, or a relay server.

According to an embodiment of the disclosure, each component (e.g., a module or a program) of the above-described components may include a single entity or multiple entities. Some of the plurality of entities may be separately disposed in different components. According to an embodiment of the disclosure, one or more of the above-described components may be omitted, or one or more other components may be added. Alternatively or additionally, a plurality of components (e.g., a module or a program) may be integrated into one component. In such a case, according to various embodiments, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, including one or more storage media, storing instructions; and
at least one processor, including processing circuitry, communicatively coupled to the display and the memory,
wherein the instructions, when executed by the at least one processor individually or collectively, cause the electronic device to:
execute an intelligent assistant based on a first user input for executing the intelligent assistant,
through the display, in response to execution of the intelligent assistant, provide at least one recommended task determined based on context information related to the electronic device,
through the display, obtain a second user input for selecting any one recommended task from among the at least one recommended task,
based on obtaining the second user input, execute a task corresponding to the recommended task in a background, and
based on completion of the task executed in the background, through the display, provide a guide message indicating that the task has been completed.

2. The electronic device of claim 1, wherein the context information includes at least one of information about at least one application being executed in a foreground, text being provided through the display, at least one image being provided through the display, or activity history information of a user.

3. The electronic device of claim 1, wherein the instructions, when executed by the at least one processor individually or collectively, cause the electronic device to:
generate a first prompt for providing the at least one recommended task using the context information and input the generated first prompt to a trained machine learning model.

4. The electronic device of claim 3, wherein the first prompt includes at least one of a first prompt element including a first command for causing the machine learning model to suggest the at least one recommended task using the context information, a second prompt element including activity history information of a user, a third prompt element including other context information except for the activity history information, or a fourth prompt element including a description of output data.

5. The electronic device of claim 3, wherein the instructions, when executed by the at least one processor individually or collectively, cause the electronic device to:
generate a second prompt for performing a task corresponding to the recommended task and input the generated second prompt to the machine learning model.

6. The electronic device of claim 5, wherein the second prompt includes at least one of a fifth prompt element including a second command for performing the task, a sixth prompt element including information about whether confirmation of a user is required for completion of performing the task, a seventh prompt element including the context information, or an eighth prompt element including a sequence of functions of at least one application for performing the task.

7. An electronic device comprising:
memory, including one or more storage media, storing instructions; and
at least one processor, including processing circuitry, communicatively coupled to the memory; and
wherein the instructions, when executed by the at least one processor individually or collectively, cause the electronic device to:
present a first user interface corresponding to a first application,
detect a designated input through the first user interface,
based on the designated input, obtain at least one recommended task, wherein the obtaining of the at least one recommended task is configured to identify the at least one recommended task based on context information including the first user interface and uses a machine learning model trained to generate a series of operations for executing each of the at least one recommended task,
provide a list of tasks including the at least one recommended task through the first user interface, and
in response to selection of the at least one recommended task, perform at least part of the series of operations in a background.

8. The electronic device of claim 7, wherein the instructions, when executed by the at least one processor individually or collectively, cause the electronic device to:
switch from the first user interface to a second user interface corresponding to a second application, and
provide a notification indicating an execution status of the at least one recommended task on the second user interface.

9. The electronic device of claim 7,
wherein the machine learning model includes a large language model (LLM) running on the electronic device, and
wherein the instructions, when executed by the at least one processor individually or collectively, cause the electronic device to:
provide a prompt including the context information and information about applications that can be provided in the electronic device to the large language model so that the large language model can identify the at least one recommended task.

10. The electronic device of claim 9, wherein the instructions, when executed by the at least one processor individually or collectively, cause the electronic device to:
when the at least one recommended task is selected from among the list of tasks, provide an additional prompt including the selected at least one recommended task and a user preference setting to the large language model so that the large language model can generate the series of operations.

11. The electronic device of claim 7, wherein the context information includes first content provided through the first user interface.

12. The electronic device of claim 11, wherein the context information includes second content provided through a third user interface corresponding to a third application before the first user interface is provided.

13. The electronic device of claim 12,
wherein the third application includes a communication application for communication with a counterpart, and
wherein the series of operations includes an operation of generating a message through an intelligent assistant and transmitting the generated message to the counterpart through the third application.

14. The electronic device of claim 7, wherein the at least one recommended task includes a plurality of tasks including a first task and a second task, wherein the first task corresponds to a first type requiring approval of a user in association with performing at least one operation among the series of operations, and wherein the second task corresponds to a second type not requiring approval of the user.

15. The electronic device of claim 7, wherein at least part of the series of operations is performed through another electronic device operatively connected to the electronic device.

16. A method performed by an electronic device, the method comprising:
executing an intelligent assistant based on a first user input for executing the intelligent assistant;
through a display of the electronic device, in response to execution of the intelligent assistant, providing at least one recommended task determined based on context information related to the electronic device;
through the display, obtaining a second user input for selecting any one recommended task from among the at least one recommended task;
based on obtaining the second user input, executing a task corresponding to the recommended task in a background; and
based on completion of the task executed in the background, through the display, providing a guide message indicating that the task has been completed.

17. The method of claim 16, wherein the context information includes at least one of information about at least one application being executed in a foreground, text being provided through the display, at least one image being provided through the display, or activity history information of a user.

18. The method of claim 16, further comprising:
generating a first prompt for providing the at least one recommended task using the context information and input the generated first prompt to a trained machine learning model.

19. A method performed by an electronic device, the method comprising:
presenting a first user interface corresponding to a first application;
detecting a designated input through the first user interface;
based on the designated input, obtaining at least one recommended task, wherein the obtaining of the at least one recommended task is configured to identify the at least one recommended task based on context information including the first user interface and uses a machine learning model trained to generate a series of operations for executing each of the at least one recommended task;
providing a list of tasks including the at least one recommended task through the first user interface; and
in response to selection of the at least one recommended task, performing at least part of the series of operations in a background.

20. The method of claim 19, further comprising:
switching from the first user interface to a second user interface corresponding to a second application; and
providing a notification indicating an execution status of the at least one recommended task on the second user interface.
